(19) United States
(12) Patent Application Publication
(10) Pub. No.: US 2017/0217670 A1
(43) Pub. Date: Aug. 3, 2017

(54) PACKS AND MACHINE FOR PREPARING BEVERAGES

(71) Applicant: NESTEC S.A., Vevey (CH)

(72) Inventors: Silvio BUTSCHER, Chezard-St-Martin (CH); Jean-Luc DENISART, Cully (CH); Cynthia SCHERZ, Allaman (CH)

(21) Appl. No.: 15/329,308

(22) PCT Filed: Jul. 23, 2015
(86) PCT No.: PCT/EP2015/066817

§ 371 Date: Jan. 26, 2017

(30) Foreign Application Priority Data
Jul. 30, 2014 (EP) 14179079.0

(51) Int. Cl. B65D 85/804; A47J 31/36; B65D 75/58

(52) U.S. Cl. CPC B65D 85/8043; B65D 75/5883; A47J 31/369

(57) ABSTRACT

The invention concerns a pack (1) with an inner volume (2) in which a food or beverage ingredient (7) is stored and in which a beverage is produced when water is introduced inside, said inner volume (2) being defined by sheets of material (10) joined to one another at their edges and said inner volume (2) presenting a generally plane shape defining a plane (P) vertically oriented during beverage production, said pack comprising at least one inlet (3) for introducing water in the inner volume and at least one outlet (4) for delivering the beverage from said inner volume, said water inlet and said beverage outlet being included in at least one insert (5) and being positioned at the bottom of the pack and being at least partially positioned between two joined edges of the sheets of material (10), and wherein the pack comprises a liquid outlet (6) in at least one insert, said liquid outlet being closed by one sheet of material (10) defining the inner volume (2).

### FIELD OF THE INVENTION

The present invention relates to packs and machines for the preparation of foods or beverages from packs comprising a food or beverage ingredient.

### BACKGROUND OF THE INVENTION

It is known to prepare beverages by introducing a capsule containing a beverage making ingredient, such as ground coffee or instant coffee, in a beverage dispensing machine and injecting water into the capsule. The beverage making ingredient is extracted or dissolved into water to form the beverage. The beverage flows out of the capsule through a suitable outlet.

Different capsules have been developed in the past that can differentiate at least by the nature of the capsule body used for storing the food or beverage ingredient. Whereas most of the capsules are made of a rigid body or semi-rigid body (e.g. made though injection moulding, thermoforming, deep drawing, . . . ) flexible types of packs or sachets can be made out of foil materials. Flexible packs have generally the advantage to semi-rigid and rigid capsules that less amount of material is used to pack the product which leads to overall less production cost and lower life cycle impact shown in several life-cycle assessments.

WO 99/05044, GB 2 374 856 and WO 2012/175985 describe such a flexible pack made of two sheets of flexible air-and liquid-impermeable material bonded on theirs edges to define an inner volume for storing the beverage ingredient. The pack comprises an inlet nozzle at its top for introducing water that is mixed with the beverage ingredient inside the inner volume. The beverage is evacuated through a beverage outlet at the bottom of the sachet. The outlet is created further to bursting of the pack under the pressure of water introduced in the sachet. Generally the outlet is created due to the separation of the bottom edges of the flexible sheets further to the effect of heat or pressure in the sachet. According to a particular embodiment a spout can be introduced at the bottom of the pack: in that embodiment, the bottom edges of the flexible sheets do not separate and the beverage is evacuated by the spout.

These flexible sachets present drawbacks. Generally the opening of the beverage outlet is obtained by increase of pressure inside the sachet. Yet this pressure increase is not recommended for the preparation of some beverages because it creates bubbles at the surface of the beverage; for example it is not desired for the preparation of tea. Besides there can be a risk that the packages may not rupture at the desired pressure and that it can finally opens up in an uncontrollable explosion. For this reason the apparatus comprises means for totally enclosing the pack in the machine during beverage preparation and avoid damages or injuries for the operator.

WO 2011/024103 describes a pack for preparing a beverage defining an inner volume for storing the beverage ingredient. The inner volume is closed at its top by a rigid piece that integrates the water inlet and the beverage outlet. The inlet and the outlet are always opened meaning that no risk of burst is possible in such a pack.

WO 2013/019963 describes a pack for preparing a beverage defining at least one inner volume for storing the beverage ingredient. The inner volume is closed at its bottom by a rigid piece that integrates a fluid inlet and a beverage outlet. The machine for preparing a beverage from the pack comprises a sensor for stopping the introduction of fluid in the pack when pressure is too high in the pack. Once pressure has decreased, fluid can be introduced again. No solution is proposed for a pack in which pressure would not decrease.

It is now proposed a new pack for the preparation of a food or beverage that improves the hereabove problems in terms of manufacturing, beverage preparation simplicity and cleanliness leading to an optimal overall beverage quality.

Moreover the present invention aims to propose a new flexible pack in which a beverage can be prepared in a safe way that is with limited risk of bursting.

Another aim of the present invention is to propose a machine for preparing a beverage with flexible packs and enabling the evacuation of the liquid contained in the pack to avoid bursting.

Another aim of the present invention is to propose a machine for preparing a beverage with flexible packs wherein liquid in the pack can be evacuated in in a proper way in case of detection of a bursting risk.

### SUMMARY OF THE INVENTION

According to a first aspect, the invention concerns a pack with an inner volume in which a food or beverage ingredient is stored and in which a beverage is produced when water is introduced inside,

said inner volume being defined by sheets of material joined to one another at their edges and said inner volume presenting a generally plane shape defining a plane (P) vertically oriented during beverage production,
said pack comprising at least one inlet for introducing water in the inner volume and at least one outlet for delivering the beverage from said inner volume,
said water inlet and said beverage outlet being included in at least one insert and being positioned at the bottom of the pack and being at least partially positioned between two joined edges of the sheets of material, and
wherein the pack comprises a liquid outlet in one insert, said liquid outlet being closed by one sheet of material defining the inner volume.

Preferably the inner volume of the inner volume is inflatable. According to the present invention “inflatable” means that the volume of the pack is able to increase when it is filled with a liquid.

The inflatability of the pack generally depends on the nature of the sheets of material, said sheets being preferably flexible.

Preferably the pack comprises two flexible water impermeable sheets joined to one another to define the inner volume. As a consequence the pack itself is substantially flexible and looks like a pouch or sachet. By flexible, it is meant that the sheets can be bent easily. The resulting pack can be bent also; it is soft and can be deformed contrary to rigid containers. The flexible sheet material can be plastic laminates, metallised foil or alufoil or fibre base material. According to the invention the two flexible water impermeable sheets can be formed of one single flexible water impermeable sheet folded in half and joined at its free edges.

The pack presents a generally plane shape that is essentially vertically oriented during beverage production.

According to a specific embodiment the pack can comprise more than two sheets, in particular to increase the size of the inner volume, and for example the inflatability. At least another sheet can be joined to the two first sheets that define the inner volume and the generally plane shape according to plane (P). For example, said other sheet(s) can create a doypack shape for the inner volume of the pack. Generally said other sheet(s) is/are joined to the edges of the two first sheets of material which do not comprise the water inlet and the beverage outlet.

In the present invention the insert(s) in which the water inlet, the beverage outlet and the liquid outlet are included is/are preferably rigid. Preferably the inserts are made of a rigid plastic material. This plastic material can be selected in the list of: polypropylene, polyethylene, polyethylene terephthalate and polylactic acid. According to a less preferred embodiment the insert can be made out of a metal like aluminium or tin-plate. The insert(s) can be injection molded.

According to the preferred embodiment the pack comprises one single insert including the water inlet, the beverage outlet and the liquid outlet, said single insert being positioned at the bottom of the pack and being partially positioned between two joined edges of the sheets of material.

The single insert is at least partially inserted between the joined bottom edges of the sheets of material. In particular the single insert is positioned in joined bottom edges so that the water inlet is closed by one sheet of material defining the inner volume. The external end of beverage outlet is positioned under the joined bottom edges of the sheets of material. Preferably the beverage outlet is not covered by the sheet. Yet it can be visually hidden by a part of the sheet e.g. by a skirt of the sheet.

The single insert is preferably positioned at or next to the middle of the bottom of the pack. It can also be positioned in the corner of the pack when the latter presents a corner.

According to one preferred mode the pack can be made of only one flexible material sheet, said sheet being folded at the top of the pack and bonded on its edges to define the inner volume, the bottom joined edge including the insert. This embodiment constitutes a particularly easy way to manufacture the pack since it requires the cutting of only one piece of sheet—most preferably according to a rectangular shape—and its folding to create the inner volume for the food or beverage ingredient. The single insert can be introduced in the bottom edge during the sealing of the edges.

According to a less preferred mode the pack can be made of two flexible material sheets, said sheets being bonded on their edges to define the inner volume, the bottom joined edges including the insert. The single insert can be introduced in the bottom edges during the sealing of these edges, two other side edges of the pack can be bonded so that the inner volume is defined and beverage ingredient can be introduced in said inner volume. Finally the last edges can be bonded to close the inner volume.

The single insert can be positioned at any place at the bottom of the pack between the both lateral sides of the bottom; it can be positioned at a bottom lateral side in particular a corner if the pack is globally rectangular or at any place between the corners. In the pack the water inlet and the beverage outlet of the pack are both simultaneously included in the same single insert. This feature covers the fact that the water inlet and the beverage outlet are part of the same insert piece in the pack. Yet this insert can be produced by the association of several parts before the complete piece is used for manufacturing the pack. In particular different parts can be clipped together to form the final single insert before said single insert is used for manufacturing the pack.

Preferably the single insert of the pack presents a shape for cooperating with the pack receiving area of a beverage production machine. In particular it can present a shape configured for sliding in the slot of the receiving area of a beverage production machine like an iron shape.

According to the preferred embodiment of the invention, before beverage preparation step, the beverage outlet is closed at its end. Generally the beverage outlet is closed by manufacturing and is configured for being opened at beverage production step. By “closed by manufacturing” it is meant that the pack is manufactured with a closed beverage outlet. This closure guarantees hygienic and shelf life protection.

According to said embodiment the beverage outlet can be closed by a plug configured for being removed from the beverage outlet to open it at beverage production and said plug comprising a bond attached to the pack, preferably to the single insert, for maintaining the plug attached to the pack after the opening of the beverage outlet, said plug being positioned under the joined bottom edges of the sheets of material,

Since the beverage outlet is closed by a plug, said plug comprising means for maintaining it attached to the pack after the opening of the beverage outlet, the plug does not fall in the beverage during its production. The means for maintaining the plug attached to the pack is usually a bond, said bond is preferably attached to the single insert.

Preferably the plug is part the single insert comprising the beverage outlet and the water inlet. Preferably the beverage outlet is a pipe and the connection between said pipe and the plug presents a mechanical weakness. This mechanical weakness can be a narrowing so that it can be made easy to cut or tear off the plug with a beverage outlet opening device of a beverage preparation machine. This reduced transversal section of the connection between the plug and the beverage outlet pipe creates a weakness. As a consequence the fact of pulling on the plug, facilitates the tearing of the material, of which the single insert is made of, at the level of this connection. The plug can be pulled according to a downwardly oriented direction or a laterally oriented direction or a combination of these both directions.

Preferably the connection between the pipe and the plug presents a smaller section than the plug upper surface and preferably smaller than the pipe section. Since the plug upper surface is larger than the connection section, it provides a surface to have a hold to tear the plug or to anchor a pulling device, for example to anchor a tearing device like the teeth of a fork.

Preferably the bond is attached to the single insert for maintaining the plug attached to the pack after the opening of the beverage outlet is configured for being bent. Consequently after being bent the plug remains away from the beverage outlet. According to that preference the bond is usually made of plastic. The bond can be made so thin that it is flexible. Once detached from the plug it can be moved away from the beverage outlet easily by a bond retaining device of a beverage preparation machine. According to a particular embodiment the plastic bond can present a notch in order to facilitate bending. So the bending of the bond by the retaining device of the machine is facilitated and the bond remains bent even if it is not retained by the bond retaining device of the machine. Preferably the notch is positioned close to the point of attachment of the bond to the single insert.

Preferably the bond is part of the single insert. According to the preferred embodiment the single insert comprises the water inlet, the beverage outlet, the plug and the bond of the plug. The single insert is preferably injection molded. In particular when the insert is injection molded, the design of the injection molded insert comprises the plug and the bond. This injection moulding of the insert including the water inlet, the beverage outlet, the plug and the bond in one single piece enables again to reach several aims with the use of only one material: the plastic for producing the insert comprising the water inlet and the beverage outlet is used to close the external end of the beverage outlet.

Internally the beverage outlet is preferably configured so that it delivers the beverage as a free flow once it is opened. The beverage can flow from the outlet by simple gravity fall. According to the preferred embodiment the outlet is a tube extending essentially vertically at the bottom of the single insert. An advantage of the outlet of the pack of the present invention is that there is no need to implement a particular connection between the beverage outlet and the beverage machine when a beverage is produced e.g. for directing the flow of beverage delivered at the outlet. The beverage can flow from the pack beverage outlet directly in a drinking cup.

The pack can comprise an excrescence enabling the handling of the pack.

The external shape of the pack is generally essentially rectangular.

Preferably at its bottom, the pack can present notches on each side of the single insert in order to facilitate its introduction in a beverage preparation machine comprising a receiving area presenting a shape corresponding to bottom design of the pack created by the notches.

The pack can comprise recognition means readable by the beverage preparation means. Such recognition means can be mechanical codes, optical codes, RFID tags, bar codes, magnetic codes.

According to the present invention the food or beverage ingredient of the pack can be comprised within the list of: soups, fruit juices, vegetable juices, bouillons, coffee, chocolate, tea, milk or creamer, or a combination thereof.

According to one embodiment the food or beverage ingredient can be a soluble food or beverage ingredient. In that embodiment water dissolve the soluble food or beverage ingredient. Preferably the food or beverage ingredient is a soluble food or beverage ingredient selected in the list of:

instant coffee powder, milk powder, cream powder, instant tea powder, cocoa powder, soup powder, fruit powder or mixture of said powders,

a coffee concentrate, a milk concentrate, a syrup, a fruit concentrate, a tea extract.

The powders can be agglomerated or sintered. The powders or liquid concentrates can be mixed with solid pieces for example for preparing soups with solid pieces.

According to another embodiment the food or beverage ingredient can be an infusable food or beverage ingredient like a roast and ground coffee or tea leaves. In that embodiment water extracts the infusable ingredient.

As mentioned above the insert including the water inlet is enclosed in the pack by the sheet(s) of material that defines the inner volume of the pack.

According to a less preferred embodiment the water inlet can be positioned in the pack so that it is almost totally essentially vertically oriented during beverage production.

In the present invention the external end of the water inlet represents the end of the water inlet channel that cooperates with a water supply at the outside of the pack whereas the internal end of the water inlet represents the end of the water inlet channel that delivers water inside the pack.

According to the preferred embodiment the external end of the water inlet is oriented essentially perpendicularly to the plane (P) defined by the inner volume. Accordingly the water inlet is at least partially essentially horizontally oriented during beverage production.

In said last embodiment the external end of the water inlet is preferably covered by said sheet of material. Consequently the same piece of material can be used to simultaneously create the inner volume of the pack, close the water inlet and protect the external end of the water end. Due to the enclosure of the beverage inlet in the pack there is no need for a particular membrane for closing the water inlet. The invention provides a pack that is easy to manufacture and guarantees hygienic and shelf life protection of the food and beverage ingredient and the produced beverage.

Preferably the single insert presents ribs on its external surface for improving the adhesion with the flexible material sheet during sealing. In particular a raising edge can surround the water inlet so as to improve air and water tightness around it.

Preferably the insert is configured so that the longitudinal axis of the water inlet channel at its internal end is almost comprised in the vertically oriented plane P.

Preferably the water inlet can be configured so that the direction of the water flow in the external end of the water inlet is almost perpendicular to the direction of the water flow in the internal end of the water inlet. In this embodiment the internal design of the water inlet enables a globally perpendicular change of orientation of the water flow from the external end of the water inlet (that faces the external part of the pack) to the internal end of the water inlet (that faces the internal part of the pack).

In a particular mode the external end of the water inlet can comprise an inlet chamber which comprises an evacuation end, said evacuation end being an injection hole configured for directing water in the inner volume of the pack in a direction almost perpendicular to the inlet chamber longitudinal axis. Preferably the inlet chamber is globally horizontally oriented. This chamber is usually configured for receiving a hollow needle for injecting water. It generally presents a circular section. This chamber presents the advantage of creating a distance between the end of the hollow needle and the inner volume which stores the beverage ingredient and consequently avoids the contamination of the needle. Most preferably the chamber evacuation end is a hole pierced in the lateral wall of the chamber.

According to one particular embodiment the water inlet is configured for introducing water under the form of a jet in the inner volume of the pack. By jet it is understood a stream of liquid that comes out of the water inlet and in the inner volume of the pack quickly and with force. Then the water inlet is configured for introducing water in the inner volume of the pack with a high velocity. Preferably the water inlet is configured for introducing a water jet in the inner volume of the pack, said water jet presenting a velocity of at least about 20 m/s, preferably at least 30 m/s. According to said first embodiment the water inlet is configured for transforming the pressurized water introduced by a beverage machine in the pack in a high velocity water jet in the inner volume of the pack. Such a configuration can be obtained by placing a constriction in the water path in the water inlet to reduce the size of the section of the water inlet. Due to the small surface of the inlet section pressurized creates a jet of water in the inner volume.

In general the water inlet comprises a hole presenting a transverse section with a surface area equivalent to the surface of a circular surface of diameter of at most 1 mm, preferably at least 0,24 mm.

The velocity for water emerging from the injection hole usually depends from the pressure of the water introduce at the water inlet. The invention generally applies for water pressurised between 2 and 10 bar, preferably of about 7 bar. For such values of pressurized water the water inlet generally comprises an injection hole presenting a transverse section with a surface area equivalent to the surface of a circular surface of diameter comprised between 0,2 and 0,8 mm, preferably between 0,3 and 0,5 mm and even more preferably of about 0,4 mm.

But when water is pressurized at more than 11 bar the water inlet preferably comprises an injection hole presenting a transverse section with a surface area equivalent to the surface of a circular surface of diameter comprised between 0,5 and 1,5 mm, preferably of about 1 mm.

The small surface of the injection hole presents the advantage of avoiding any back flow of liquid contained in the inner volume of the pack through the water inlet.

For the same diluent supply pressure the surface of the diluent injection hole can vary according to the nature of the food and beverage ingredient inside the pack. In particular when the ingredient is difficult to dissolve a smaller injection hole creates a jet with a higher velocity which improves agitation and dissolution in the pack.

Preferably the pack presents a plane shape oriented along a plane essentially vertically oriented during beverage production and the water inlet orientates the jet of water in a direction comprised in said plane. The water jet introduced from the bottom into the pack is developing into circular and/or spiral movements creating turbulences, frictions and high contact surfaces between the water molecules and the product particles. In average the water molecules have several turns within the sachet until they leave the sachet with the beverage. Packs with single insert placed in the corner of an essentially rectangular pack also improve reconstitution.

This particular embodiment with creation of a jet is particularly interesting for packs comprising soluble beverage ingredients.

According to another particular embodiment the creation of a water jet in the pack is not desirable, for example for packs comprising infusable ingredients. Consequently the size of the water injection hole can be configured to avoid a jet in the inner volume of the pack.

The pack can present various external shapes like rectangular, square or round shapes. The inner volume of the pack can present the same shape as the external shape of the pack. According to one particular mode the inner volume can present a shape configured for improving the movement of the water and the beverage in the pack during beverage preparation. In particular for packs with external rectangular or square shapes at least one of the inside corner, preferably the both, can present a slanted shape. This feature avoids that beverage or food ingredient remains blocked in the right-angled corner. This feature can be obtained by sidewise sealing the corner of the pack.

According to the invention the single insert comprises a centring hole extending essentially perpendicularly to the generally plane (P) shape of the inner volume. This hole can be a traversing hole through the insert or a deep recess through the insert. It is configured for cooperating with a centring and immobilization device of a beverage preparation machine when the pack is introduced in said machine.

According to one embodiment the hole is positioned under the joined bottom edges of the sheets of material so as to remain free for cooperating with the centring and immobilization device of the beverage preparation machine.

According to another embodiment the hole is at least partially covered by the bottom of the sheets of material. This embodiment gives a nicer external aspect to the pack.

According to a particular mode of said embodiment the part of the bottom of the sheet of material covering the hole can be configured for being easily tearable, deformable or bendable when a pressure is exercised on it. For example when the centring device of the beverage preparation machine is applied on this part, this part can be deformed, bent or torn to let the centring device enter in the hole.

According to the invention the pack comprises an insert including a liquid outlet, said liquid outlet being closed by one sheet of material defining the inner volume.

The liquid outlet is a conduit different from the beverage outlet and the water inlet mentioned above. Consequently the pack comprises at least three different conduits for fluids. Preferably these conduits are closed to the atmosphere before the pack is introduced in the machine and the beverage is prepared. Only at the step of the beverage preparation the machine opens the beverage outlet and pierces the sheet covering the water inlet. Only if necessary, the sheet covering the liquid outlet is opened.

The liquid outlet is designed for evacuating any liquid present in the pack once said liquid outlet is opened. Such an evacuation can be necessary if the beverage outlet cannot be opened or is blocked for example by a beverage ingredient powder cake positioned in the beverage outlet. In that case beverage would not be able to be dispensed from the pack while water is being introduced in the water inlet which could lead to bursting of the pack. The liquid outlet is designed for evacuating any liquid in the pack and avoiding bursting.

The liquid outlet in the single insert is closed by one sheet of material defining the inner volume. In the preferred embodiment wherein the water inlet, the beverage outlet and the liquid outlet are in the same single insert, the liquid outlet is generally provided on the lateral side of the single insert. Consequently the external end of the liquid outlet can be covered and closed by said sheet of material.

Preferably the liquid outlet is positioned next to the top of the single insert. Consequently the risk that it is blocked by powder is reduced.

Preferably the liquid outlet is a hole in the lateral side of the single insert, said hole communicating with the inner volume of the pack. Accordingly any liquid present in the inner volume of the pack is able to flow through the liquid outlet once said outlet is opened.

Preferably the hole of the liquid outlet presents a transverse section with a surface area sufficient to avoid any blocking issue, for example equivalent to the surface of a circular surface of diameter of at least 3 mm. Preferably the length of the hole is as short as possible to avoid any other blocking issue in the hole too. Preferably the length of the hole is at most 2 mm.

Preferably the upper surface of the single insert presents at least one hollowed out volume and the liquid outlet communicates with said volume. Said volume at the top of the single insert is preferably as large as possible so that the problem of powder caking is avoided in this area and liquid in the pack can have an easy access to the liquid outlet. Preferably the upper surface of this hollowed out volume represents at least 50% of the upper surface of the single insert.

A liquid outlet presenting a large hole and communicating with a large hollowed out volume at the upper surface of the single insert decreases the risk of presence of blocking elements in this area and guarantees a good evacuation of the liquid from the pack through the liquid outlet in case of emergency and increases the emptying speed of the liquid form the pack.

According to one embodiment the water inlet and the liquid outlet are positioned on the same lateral side of the single insert. In this embodiment both the water inlet and the liquid outlet are covered, and consequently closed, by one sheet of material.

Yet depending on the interface with the machine cooperating with the pack, the water inlet and the liquid outlet can be positioned on opposed lateral sides of the single insert

According to a second aspect the invention concerns a machine for preparing a beverage from a pack such as described above, said machine comprising at least:

a water supply,

a pump for pumping water from the water supply,

a water needle for injecting water in the water inlet of the pack,

a sensor for detecting an increase of pressure or volume in the pack during beverage preparation,

a hollow evacuation needle for piercing the sheet of material closing the liquid outlet and for evacuating liquid from the pack.

The beverage preparation machine usually comprises a water fluid system in order to deliver water to the water needle. The fluid system generally comprises at least a water supply, a pump for pumping water from the water supply and optionally a fluid temperature adjustment device (heating or cooling).

The sensor is preferably configured for detecting an abnormal increase of pressure or volume of the pack. Indeed if the beverage outlet does not evacuate the beverage, the introduction of water through the water needle in the pack creates an increase of volume of the pack due to inflation of sheets. The inflation can be such that at least one of the inflated sheets by-pass its usual position in the pack receiving area of the machine and contacts the sensor.

If the sensor senses an abnormal inflation of the pack, the control unit of the machine causes the introduction of the hollow needle in the liquid outlet in order to deflate the pack. The hollow needle is preferably sharp in order to pierce the sheet covering the liquid outlet. Preferably the hollow needle presents a diameter configured for entering inside the liquid outlet. Preferably the hollow needle is surrounded by a seal so that when the needle is introduced in the liquid outlet, the seal creates a liquid tight connection with the pack and avoids any liquid leaking.

Preferably the hollow needle is connected to a bin or a drip tray. Consequently liquid urgently evacuated from the pack is not dispensed in the drinking cup of the user. The evacuation of the content of the pack can be hidden, the content is properly evacuated.

The sensor can be chosen any known device detecting a movement of the pack, like a mechanical finger, a pallet sensor, an optical detector, a capacitive sensor, an RFID sensor or any other electronical or electrical sensor.

The machine usually comprises a pack receiving area for positioning the pack in the machine so that the generally plane shape of the inner volume is vertically oriented and so that the single insert is positioned at the bottom of the pack. The pack receiving area also enables the correct positioning of the single insert in front of the needles.

The pack receiving area for positioning the pack in the machine is generally designed to induce the customer to correctly place the pack in the machine for the preparation of a beverage with the single insert at the bottom and so that the water inlet faces the water needle. In particular the design of the pack receiving area can match with the general external shape of the pack. The pack itself can present visual indicators to correctly orientate the pack in the machine, especially if it presents a general symmetric shape with the single insert placed in the middle of the bottom of the pack.

Preferably the single insert of the pack presents a shape for cooperating with the pack receiving area of the beverage production machine and preferably the single insert of the pack presenting a shape configured for sliding in a slot of the receiving area of a beverage production machine.

Preferably the machine comprises an immobilization and centring device configured for cooperating with the centring hole of the single insert. The immobilization and centring device can be a rod configured for sliding in the centring hole of the single insert.

According to the preferred embodiment the machine prepares a beverage from a pack, said pack comprising a beverage outlet closed by a plug, said plug being attached to the pack, preferably to the single insert, by a bond for maintaining the plug attached to the pack after the opening of the beverage outlet, and the machine comprises:

a device for removing the plug of the beverage outlet of the pack,

a device for pulling the plastic bond of the plug away from the beverage outlet of the pack once the plug is removed from the beverage outlet.

According to a third aspect the invention concerns a system of a pack such as described above and a machine such as described above.

According to a fourth aspect the invention concerns a method for detecting abnormal inflation of a pack such as described above and for emptying liquid from said pack with a machine such as described above comprising the steps of:

detecting an increase of pressure or volume in the pack with the sensor,

piercing the sheet of material closing the liquid outlet with the hollow needle and evacuating liquid from the pack.

Preferably the machine comprises a control unit for receiving an input from the sensor when pressure or volume in the pack increases above a normal reference pressure or volume and the control unit controls the opening of the liquid outlet of the pack by introducing the evacuation needle in said liquid outlet.

In the present application the terms “bottom”, “top”, “lateral”, “horizontal” and “vertical” are used to describe the relational positioning of features of the invention. These terms should be understood to refer to the pack in its normal orientation when introduced in a beverage preparation machine for the production of a beverage as shown for example in FIGS. 1 and 6.

According to the invention “next to the bottom” means that both the inlet and the outlet are positioned on the bottom edge of the pack and/or on the bottom part of one of the lateral sides of the package. The invention covers the different variants where both the inlet and the outlet are on the same edge of the pack that is both on the bottom edge or both at the bottom part of a lateral side and where either the outlet or the inlet is on the bottom edge and respectively the inlet or the outlet is at the bottom part of a lateral side of the pack. According to the invention the bottom part of a lateral side of the pack generally corresponds to the part of said lateral side positioned below the middle part of the pack and preferably closer to the bottom part of the pack rather than the middle part of the pack.

In the present invention the term “water” covers any aqueous diluent that can be mixed with a soluble beverage ingredient to prepare a beverage, like water, carbonated water, milk. It is preferably still water.

### BRIEF DESCRIPTION OF THE DRAWINGS

The characteristics and advantages of the invention will be better understood in relation to the following figures, in which:

FIG. 1 illustrates a pack of the present invention,

FIG. 2 is a perspective view of the single insert of the pack of FIG. 1,

FIG. 3 is a side view of the single insert of the pack of FIG. 1,

FIG. 4 is a top view of the single insert of the pack of FIG. 1,

FIG. 5 is a section view of the single insert of the pack of FIG. 4 according to AA,

FIG. 6 is a section view of the single insert of the pack of FIG. 4 according to BB,

FIG. 7 is a schematic drawing of beverage preparation machine according to the present invention.

### DETAILED DESCRIPTION OF THE DRAWINGS

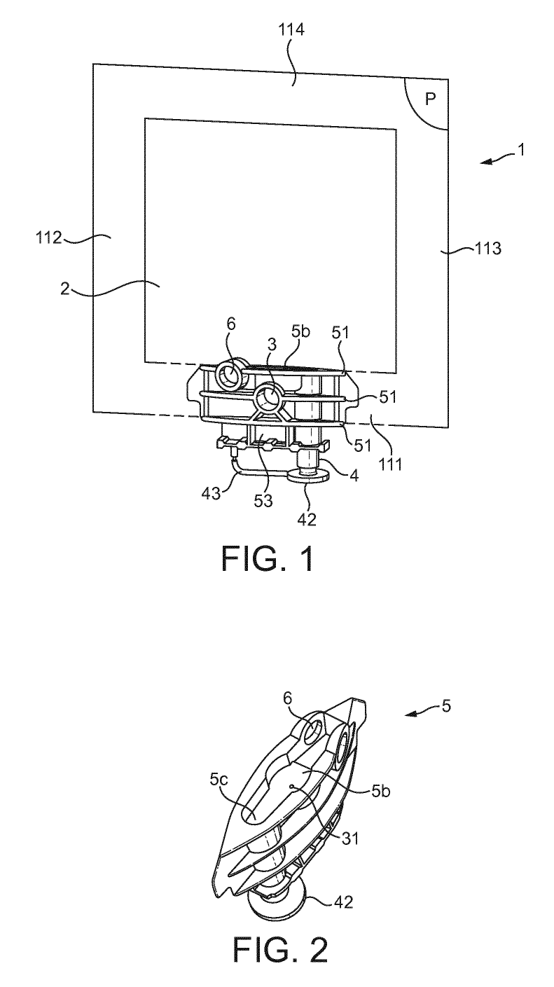

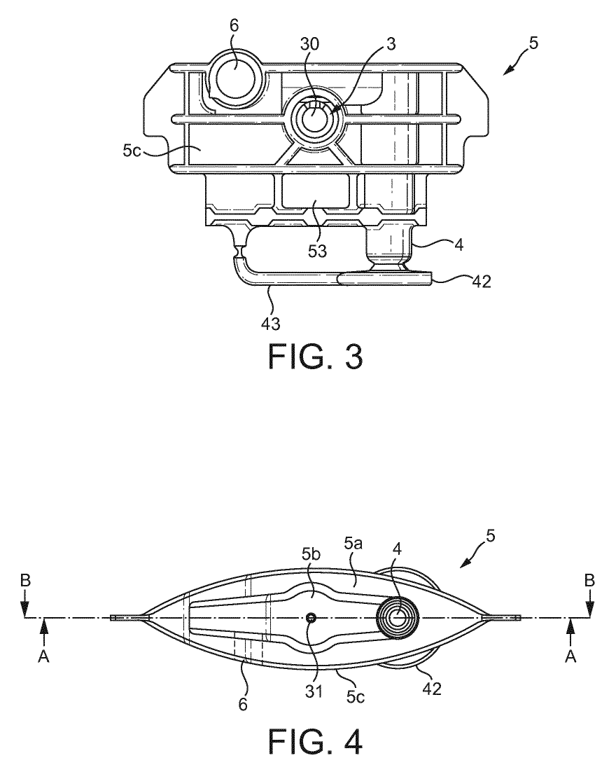

FIG. 1 illustrates a pack 1 for producing a beverage according to the invention. The bottom of the pack has been made transparent to show the single insert 5 that is enclosed at its bottom. The pack comprises two flexible water impermeable sheets joined one to another on their edges 111, 112, 113, 114 to define an inner volume 2. These two sheets can be obtained by folding one sheet in its middle to form the top 114 of the pack too; then only edges 111, 112, 113 have to be bonded together. The bonding can be obtained by heat sealing. A food or beverage ingredient is disposed within said inner volume. The inner volume 2 presents a generally plane shape defining a plane (P) vertically oriented during beverage production.

The insert 5 is a single piece of material preferably of plastic. It includes simultaneously the water inlet 3 for introducing water in the inner volume and a beverage outlet 4 for dispensing the beverage or food issued from the mixing of the food or beverage ingredient with water. It also comprises the liquid outlet 6 for evacuating any liquid from the inner pack if it is opened.

In the illustrated embodiment both the water inlet and the liquid outlet external ends are positioned on the same lateral side 5c of the insert. They are covered and closed by the same sheet. According to another embodiment (not illustrated), the liquid outlet can be on the opposite lateral side of the sing le insert.

The insert is positioned at the bottom of the pack at the bottom side 111 of the pack. The insert presents fins 51 and preferably a raising edge around the water inlet 3 and the liquid outlet 6 on the lateral sides of the insert to improve the adhesion with the flexible material sheet during sealing.

As illustrated in FIG. 6 the water inlet 3 can present at its external end an inlet chamber 30. This chamber is a hollow cavity; it is globally horizontally oriented. Its dimensions are configured for receiving the hollow needle of a beverage preparation machine in order to inject water. The inlet chamber presents an evacuation end in its upper lateral wall: this evacuation end corresponds to an injection hole 31 from which water can be injected in the inner volume 2, for example under the form of jet. Due to the configuration of the water inlet the water can be injected essentially horizontally at its external end 3a and essentially vertically in the inner volume 2 of the pack. This configuration is adapted for dissolving soluble ingredients in the inner volume.

According to another embodiment (not illustrated), the creation of a jet is not necessary (for example for an infusable beverage ingredient in the inner volume), the injection hole 31 can be bigger than in FIG. 1 and can be oriented differently with the simple function of filling the pack with water.

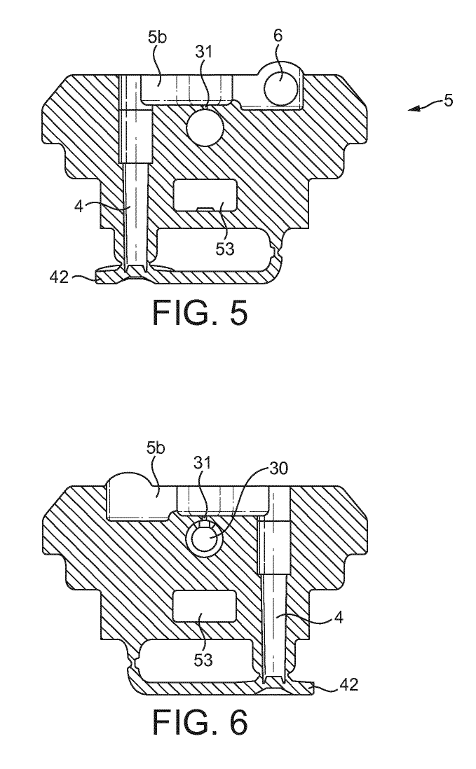

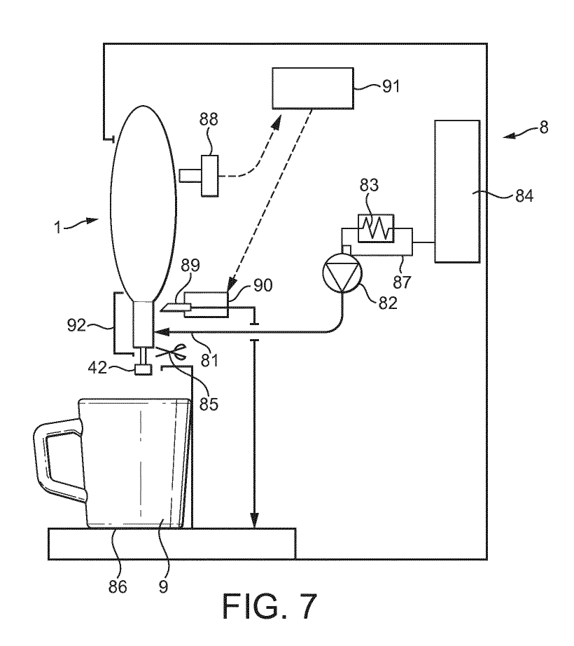

As illustrated in FIGS. 5 and 6, the beverage outlet 4 is a vertical pipe in the insert. It preferably presents a diameter for dispensing the beverage under free flow. The beverage outlet is closed at its external end by a plug 42. This plug is made of one piece with the rest of the insert.

The pack comprises a plastic bond 43 for maintaining the plug 42 attached to the pack after removing of the plug from the beverage outlet. Consequently it avoids that the plug falls in the beverage during its production. This bond is made of one piece with the rest of the insert.

The pack comprises a centring hole 53 extending essentially perpendicularly to the generally plane (P) shape of the inner volume and through the insert. It is positioned under the joined bottom edges 111 of the sheets of material so as to remain free for cooperating with a centring and immobilization device of the beverage preparation machine.

FIGS. 2 and 4 are top views of the single insert 5. They illustrate the presence of a hollowed out volume 5b in the upper surface 5a of the single insert. FIG. 2 shows that the liquid outlet 6 communicates with said volume 5b and consequently with the inner volume 2 in the pack. This hollowed out volume 5b extends almost through the whole surface of 5a at the top of the single insert. This large volume limits the problem of powder caking in this area, especially when soluble ingredients are in the inner pack. Consequently the liquid in the pack can have an easy access to the liquid outlet 6.

Moreover the liquid outlet 6 consists in a large hole communicating with the large hollowed out volume 5b at the upper surface of the single insert: this large hole decreases the risk of presence of blocking elements in this area and guarantees a good evacuation of the liquid from the pack through the liquid outlet 6 in case of emergency.

FIG. 6 illustrates the interaction of a pack 1 according to the present invention with a beverage preparation machine 8 according to the present invention. The machine comprises at least:

a water tank 84,

a heater 83 for heating water,

a bypass line 87 for delivering ambient water,

a valve (not illustrated) for the selection of either hot or ambient water,

a pump 82 for pumping water. The pump can deliver water at a pressure comprised between 2 and 10 bar.

a water nozzle or needle 81 for injecting water in the water inlet of the pack 1.

Preferably the machine comprises a drip tray 86 on which a drinking cup 9 can be positioned under the beverage outlet of the pack when a beverage is prepared.

The machine comprises an area 92 for receiving the pack that is configured so that the pack 1 is positioned with the single insert positioned at the bottom of the pack. The pack can be well centred and immobilised in the receiving area by a rod (not illustrated) configured for sliding in the centring hole 53 of the single insert (illustrated in FIG. 1).

According to the invention the pack is not pressurized during the beverage preparation. This effect can be obtained by opening the beverage outlet before water is introduced in the pack or simultaneously to the introduction of the water in the pack. Consequently the beverage is prepared with the both water inlet and beverage outlet being opened. The opening of the water inlet is usually made by a needle 81 for introducing water. As for the beverage outlet it can be opened by the machine when the pack is placed inside or by the user manually. The illustrated machine comprises a beverage outlet opening means 85, for example a cutter for removing the plug 42 of the beverage outlet of the pack 1 when the pack presents a plug at the beverage outlet. The cutter 85 can be positioned so that the plug of the beverage outlet is automatically cut when the pack is introduced in the machine or when the beverage preparation is activated.

The machine 1 comprises a sensor 88 for detecting an increase of pressure in the pack during beverage preparation. The area 92 for receiving the pack positions the pack 1 in the machine so that when the pack inflates in an abnormal manner, the sheets move until contacting the pressure sensor and the inflated pack is detected by the sensor 88. The detection of the inflation of the pack is transmitted to the control unit 91 of the machine which can order the evacuation of liquid from the pack. The control unit can activate a motor 90 supporting a hollow needle 89 in order to pierce the liquid outlet and evacuate liquid from the pack. The liquid is evacuated in the drip tray 86 of the machine or a bin. According to another embodiment the inflation of the pack can induce a mechanical movement in a part of the machine and a corresponding mechanical actuation of the piercing of the liquid outlet.

The system of the present invention presents the advantage of enabling the evacuation of liquid in the pack as soon as an abnormal inflation of the pack appears.

Another advantage of the present invention is that the process of introduction of water inside the pack does not have to be stopped once the process of evacuation of liquid is activated.

Another advantage of the present invention is that the liquid evacuated through the liquid outlet is not dispensed in the drinking cup of the customer. Consequently the customer does not receive a liquid that is not a well prepared beverage or not a fully prepared beverage in his/her cup and does not drink it inadvertently.

Another advantage is that the liquid is evacuated in a proper way through the hollow needle and the evacuation process is preferably hidden.

1. A pack with an inner volume in which a food or beverage ingredient is stored and in which a beverage is produced when water is introduced inside,
the inner volume being defined by sheets of material joined to one another at their edges and the inner volume presenting a generally plane shape defining a plane vertically oriented during beverage production,
the pack comprising at least one inlet for introducing water in the inner volume and at least one outlet for delivering the beverage from the inner volume,
the water inlet and the beverage outlet being included in at least one insert and being positioned at the bottom of the pack and being at least partially positioned between two joined edges of the sheets of material, and
the pack comprises a liquid outlet in one insert, the liquid outlet being closed by one sheet of material defining the inner volume.

2. A pack according to claim 1 wherein the pack comprises one single insert including the water inlet, the beverage outlet and the liquid outlet, the single insert being positioned at the bottom of the pack and being partially positioned between two joined edges of the sheets of material.

3. A pack according to claim 1, wherein the inner volume is inflatable.

4. A pack according to claim 1 wherein the liquid outlet is positioned next to the top of the single insert.

5. A pack according to claim 1 wherein the liquid outlet is a hole in the lateral side of the single insert, the hole communicating with the inner volume of the pack.

6. A pack according to claim 1, wherein the upper surface of the single insert presents at least one hollowed out volume, the liquid outlet communicating with the volume.

7. A pack according to claim 1, wherein the water inlet and the liquid outlet are positioned on the same lateral side of the single insert.

8. Machine for preparing a beverages from a pack with an inner volume in which a food or beverage ingredient is stored and in which a beverage is produced when water is introduced inside, the inner volume being defined by sheets of material joined to one another at their edges and the inner volume presenting a generally plane shape defining a plane vertically oriented during beverage production, the pack comprising at least one inlet for introducing water in the inner volume and at least one outlet for delivering the beverage from the inner volume, the water inlet and the beverage outlet being included in at least one insert and being positioned at the bottom of the pack and being at least partially positioned between two joined edges of the sheets of material, and the pack comprises a liquid outlet in one insert, the liquid outlet being closed by one sheet of material defining the inner volume, the machine comprising at least:
a water supply;
a pump for pumping water from the water supply;
a water needle for injecting water in the water inlet of the pack;
a sensor for detecting an increase of pressure or volume in the pack during beverage preparation; and
a hollow needle for piercing the sheet of material closing the liquid outlet and for evacuating liquid from the pack.

9. Machine according to claim 8 wherein the pack comprises a beverage outlet closed by a plug and the machine comprises a device for cutting or tearing the plug of the beverage outlet of the pack.

10. Machine according to claim 8, wherein the sensor detects an increase of pressure or volume of the pack.

11. Machine according to claim 8 wherein the hollow needle is connected to a bin or a drip tray.

12. Machine according to claim 8 wherein the hollow needle presents a diameter configured for entering inside the liquid outlet.

13. (canceled)

14. A method for detecting abnormal inflation of a pack with an inner volume in which a food or beverage ingredient is stored and in which a beverage is produced when water is introduced inside, the inner volume being defined by sheets of material joined to one another at their edges and the inner volume presenting a generally plane shape defining a plane vertically oriented during beverage production, the pack comprising at least one inlet for introducing water in the inner volume and at least one outlet for delivering the beverage from the inner volume, the water inlet and the beverage outlet being included in at least one insert and being positioned at the bottom of the pack and being at least partially positioned between two joined edges of the sheets of material, and the pack comprises a liquid outlet in one insert, the liquid outlet being closed by one sheet of material defining the inner volume and for emptying liquid from the pack comprising the steps of:
detecting an increase of pressure or volume in the pack with a sensor; and
piercing the sheet of material closing the liquid outlet with a hollow needle and evacuating liquid from the pack.
